(19) United States
(12) Patent Application Publication
(10) Pub. No.: US 2026/0235867 A1
(43) Pub. Date: Aug. 13, 2026

(54) GLAZING PANE

(71) Applicant: AGC GLASS EUROPE, Louvain-la-Neuve (BE)

(72) Inventor: Xavier LALOYAUX, Gosselies (BE)

(73) Assignee: AGC GLASS EUROPE, Louvain-la-Neuve (BE)

(21) Appl. No.: 19/125,806

(22) PCT Filed: Nov. 29, 2023
(86) PCT No.: PCT/EP2023/083622

§ 371 Date: Apr. 30, 2025

(30) Foreign Application Priority Data
Dec. 7, 2022 (EP) 22212062.8

(51) Int. Cl. G02B 27/01; B32B 17/10

(52) U.S. Cl. CPC G02B 27/0101; B32B 17/10036; B32B 17/10293; B32B 17/10449; B32B 2307/41; B32B 2457/20

(57) ABSTRACT

A glazing pane separating an interior space from an exterior environment with a reflective patch having a ramp profile. Additionally, a HUD system made of the same glazing pane and the use of a ramp profile on a glazing pane.

### FIELD OF THE INVENTION

The invention relates to a glazing pane separating an interior space from an exterior environment comprising a reflective patch having a ramp profile, to a HUD system comprising said glazing pane and to the use of a ramp profile on a glazing pane.

### BACKGROUND OF THE INVENTION

Glazing panes suitable for reflection of projected images are ever more gaining in performance and application fields, in at least transportation applications, specifically when HUD functionality is required.

The technology of reflective coatings obtained by deposition of metallic and/or dielectric layers by chemical vapor deposition or physical vapor deposition on glass or plastic substrates, leads to a variety of reflection performance above 10 % of reflection of p-polarized light, for example at Brewster angle. These coatings may be applied on a surface glazing pane or within a glazing pane, specifically a laminated glazing pane.

These coatings are well known to the skilled person, and have definitive advantages of quality, ease of processability and performance, with mainly only a disadvantage of cost.

Full coating on a windshield corresponds to a large coated area. In certain applications, only a black band display will be used as projection area. In those instances, only an area of the surface of the glazing pane requires a reflective coating, such that the application of a local coating will be more efficient to avoid yield loss linked to the full surface coating.

With a local coating, the solar control function may also be easier to implement in the transparent area.

When only an area of the surface of the glazing pane requires a reflective coating, either the deposition of the coating may be selective in said area, or a complete deposited coating may be decoated (removed). The second operation involves wasted materials and process complexity.

In some instances, the coating in only a selected area may result in a misalignment between coated and uncoated areas of the glazing pane, specifically if there is a difference in light transmittance between these areas.

There remains the need to provide for a display area which is only a part of a full surface of a glazing pane, such that cost drawbacks are reduced, and to avoid misalignment between coated and uncoated area of the large glazing pane.

### SUMMARY OF THE INVENTION

The present invention is intended to overcome the above drawbacks by providing a glazing pane separating an interior space from an exterior environment, having one inner surface facing the interior space and one outer surface facing the exterior environment, wherein the inner surface is provided in at least one area with a reflective patch having a perimeter, characterised in that the reflective patch has a ramp profile along at least a portion of its perimeter.

The reflective patch itself provides for high reflectivity of p-polarized radiation, be it projected from a p-polarized light source or from a mixed light source, and allows for a color-neutral display.

The particular ramp profile, by masking the extremity of the patch, assists in providing for an effective positioning but also in reducing edges defects that lead to dirt capture and/or adhesion issues of the edge of the reflective patch.

### BRIEF DESCRIPTION OF THE DRAWINGS

FIG. 1 is a schematic view of the ramp profile of the present invention.

FIG. 2 is a schematic view of a first embodiment of the present invention.

FIG. 3 is a schematic view of a second embodiment of the present invention.

FIGS. 4a and 4b are schematic views of a third embodiment of the present invention, side-view and see-through view respectively.

FIGS. 5a and 5b are schematic views of a fourth embodiment of the present invention, side-view and see-through view respectively.

FIGS. 6a and 6b are schematic views of a fifth embodiment of the present invention, top-view and see-through view respectively.

The figures are not to scale.

### DETAILED DESCRIPTION

The present glazing pane is thus used to define an inner space from an external environment. The inner space may be a room or defined space, having to be separated from the external environment. In preferred embodiments, the inner space is the interior of a vehicle.

The inner surface of the glazing pane is thus the surface facing the inner space, while the outer surface is facing the external environment.

The glazing pane may be a single sheet of glass or polymer, or may be a laminated pane of glass and/or polymeric material.

Examples of glass sheets include float glass panes or alternatively cast or drawn glass panes and can be chosen among all glass technologies such as: float clear, extra-clear or colored glass, (partially) acid etched or (partially) sand blasted glass and combinations thereof. It may be of any composition having any optical properties, e.g., any value of visible transmission, ultraviolet transmission, infrared transmission, and/or total solar energy transmission. The glass may be a soda-lime-silicate glass, an alumino-silicate glass, an alkali-free glass, a boro-silicate glass and the like. The glass may be regular a clear, colored or extra-clear (i.e. lower Fe content and higher transmittance) glass substrate. Further examples of glass substrates include clear, green, bronze, or blue-green glass substrates.

Examples of polymeric material sheets include poly(methyl meth)acrylate (PMMA), polycarbonates, polyethyleneterephthalate (PET), polyolefins, polyvinyl chloride (PVC), or mixtures thereof.

Preferred glazing panes are glass panes, useful in the provision of vehicle glazing in general.

The glass may be clear, extra-clear, or colored. These glass types are defined by their respective compositions. Said compositions may be selected from the various types of glass compositions, provided the invention is not jeopardized.

The glass may be annealed, tempered or heat strengthened glass.

Preferably, when the glazing pane is a laminated pane, it may comprise at least two glass sheets and at least one intermediate layer or interlayer.

The interlayer, or intermediate layer or laminating material, may be selected from the group consisting of ethylene vinyl acetate (EVA), polyisobutylene (PIB), polyacetals such as polyvinyl butyral (PVB), polyurethane (PU), polyvinyl chloride (PVC), polyesters, cyclo olefin polymers (COP), ionomers and/or ultraviolet curable adhesives, and others known in the art of manufacturing glass laminates. Blended materials using any compatible combination of these materials can be suitable as well. Preferably, the interlayer comprises a material selected from the group consisting of ethylene vinyl acetate and/or polyvinyl butyral.

The interlayer acts as a “bonding interlayer” since the interlayer and the glass sheets form a bond that results in adhesion between the glass sheets and the interlayer.

The interlayer to be used in the present invention may be a transparent or translucent polymer interlayer. However, for specific applications where transparency is not a requirement, the polymer interlayer may be colored or patterned. Colored interlayers may have a light transmittance of from 0 to 85%, and may be selected according to the requirements of the area used as projection area in the HUD system.

Typical thicknesses for the interlayer are 0.15 mm to 3.5 mm, preferably 0.30 mm to 1.75 mm, more preferably from 0.5 mm to 1.75 mm. Usual commercially available polymer films are polyvinyl butyral (PVB) layers of 0.38 mm and 0.76 mm, 1.52 mm, 2.28 mm and 3.04 mm. To achieve the desired thickness, one or more of those films can be used.

Reinforced acoustic insulation can be provided by using a specific interlayer, known in the field of laminated glazings.

The interlayer may have an essentially constant thickness, apart from any surface roughness that is customary in the art, or it may be a so-called wedge film, and thus have a varying thickness across its surface.

When considering a laminated glazing pane comprising two glass sheets, the first and second sheets may independently have a thickness ranging from 0.2 mm to about 15 mm, alternatively from 0.5 mm to about 10 mm, alternatively from 0.5 mm to about 8 mm, alternatively from 0.5 mm to about 6 mm. Specifically, in the automotive field, the first and second sheets may independently have a thickness ranging from 0.2 mm to 6 mm, alternatively from 0.4 to 3 mm.

Both sheets may have the same thickness, for example 0.5 mm, or 0.8 mm, or 1.2 mm, or 1.6 mm, or 1.8 mm or 2.1 mm, or 3 mm. Such symmetrical construction in glass thickness allows for ease of process and conventional sizing of the laminating process.

Both sheets may also have different thicknesses, providing for asymmetrical laminated glazings, irrespective of the position towards interior or exterior, for example pane 1=0.5 mm and pane 2=2.1 mm, or pane 1=0.8 mm and pane 2=2.1 mm, or pane 1=0.5 mm and pane 2=1.6 mm, pane 1=0.8 mm and pane 2 =1.6 mm, or pane 1=1.6 mm and pane 2=2.1 mm. Such asymmetrical constructions in glass thickness allow for flexibility in curvature, and/or in weight management and/or flexibility in light/solar modulation.

In specific instances, it may be suitable to have an asymmetrical laminated glazing having the exterior sheet having a greater thickness than the interior sheet, for example: exterior pane=2.1 mm and interior pane=0.5 mm, such that a compromise may be concluded between lighter weight and better mechanical resistance.

The present reflective patch is suitable for reflecting p-polarized radiation, at an angle of 40 to 75° incident angle, or at an angle of 50 to 70°, that is, at an angle range including the Brewster angle (57°). However, the present invention may also be suitable for reflective patches aimed at reflecting mixed reflection (s-polarized and p-polarized) or s-polarized reflection with the appropriate projector.

Such reflective patch is specifically designed to reflect p-polarized radiation in view of reflecting a projected image in a HUD system.

In general, clear glass pane have a reflectance for p-polarized light (Rppol) of 1% at an angle of 65°, and reflectance for p-polarized light (Rppol) of 0% at an angle of 57° (Brewster), and a reflectance for s-polarized light (Rspol)=35% at an angle of 65°.

The preferred reflective patch typically has a reflection for p-polarized light≥18%, preferably≥20% at Brewster angle.

Suitable preferred reflective patch may have a reflectance for p-polarized light (Rppol) of 26% at an angle of 65°; and a reflectance for s-polarized light (Rspol)=40% at an angle of 65°.

The reflective patch is preferably provided in a defined area of the inner surface of the glazing pane, said defined area being defined according to the potential display area which will be targeted by the projector of the potential HUD. The defined area may thus have any surface area dimension, as from 2 cm² , alternatively 4 cm² , alternatively 8 cm² , alternatively 10 cm² . The defined area may be up to 4 m² , alternatively up to 2.5 m² , alternatively up to 1 m ² , alternatively up to 0.5 m² , alternatively up to 0.3 m^{2 .}

The area of the glazing pane onto which the reflective patch may be affixed, may have any value of light transmittance, with TL as typically measured according to ISO 9050, with Illuminant A, at an observer opening slit angle of 2° (=III. A, 2°).

The perimeter of the reflective patch may have n edges, with n≥1, to define either a circle, an oval, a triangle, a square, a rectangle, a trapeze, or any other suitable shape.

Examples of reflective patches include a coated patch with a reflective coating suitable to reflect p-polarized light. The reflective coating may be positioned on the first surface of the patch facing the internal surface of the glazing pane, or to the second surface of the patch facing the interior space. Indeed, some reflective coatings will need protection from the ambient conditions, such as those coatings comprising functional silver layers, while others will withstand ambient conditions.

Examples of such reflective coatings suitable to reflect p-polarized light include those comprising at least one high refractive index layer having a thickness of from 50 to 100 nm, and at least one low refractive index layer having a thickness of from 70 to 160 nm, wherein the least one high refractive index layer comprises at least one of an oxide of Zr, Nb, Sn; a mixed oxide of Ti, Zr, Nb, Si, Sb, Sn, Zn, In; a nitride of Si, Zr; a mixed nitride of Si, Zr; or those comprising, in sequence starting from the substrate surface, optionally, 1) a first coating, composed of one or more high refractive index layers, the first coating having a thickness of from 1 to 100 nm, and 2) a second coating, composed of one or more low refractive index layers, the second coating having a thickness of from 1 to 220 nm, and 3) a third coating, composed of one or more high refractive index layers, the third coating having a thickness of from 40 to 150 nm, and 4) a fourth coating, composed of one or more low refractive index layers, the fourth coating having a thickness of from 40 to 200 nm, and 5) further comprising at least one first layer of absorbent material, said at least one first layer of absorbent material having a thickness of from 0.2 to 15 nm, and said absorbent material having an average refractive index n above 1 and an average extinction coefficient k above 0.1, with the averages n and k calculated over the values at the wavelengths of 450 nm, 550 nm and 650 nm; or those comprising exactly one electrically conductive layer and above and below the electrically conductive layer, a dielectric layer sequence of n optically low-refractive layers with a refractive index less than 1.8 and (n+1) optically high-refractive layers with a refractive index greater than 1.8 arranged, alternately, where n is an integer greater than or equal to 1; or those comprising four functional metal layers based on silver or silver, and five dielectric coatings such that each functional metal layer is placed between two dielectric coatings.

Preferred coatings are those free of functional silver layer, as they require less protection against oxidation.

Such coatings are deposited on the patch using typical deposition techniques, among which, PVD or CVD. Such coatings have the advantages of being easily provided on glass substrates, and resistant to exposure towards an interior space.

The patch itself may be made of any material as discussed above for the glazing pane, that is, glass and/or polymeric material.

Examples of glass patches thus include float glass or alternatively cast or drawn glass and can be chosen among all glass technologies such as: float clear, extra-clear or colored glass, (partially) acid etched or (partially) sand blasted glass and combinations thereof. It may be of any composition having any optical properties, e.g., any value of visible transmission, ultraviolet transmission, infrared transmission, and/or total solar energy transmission. The glass may be a soda-lime-silicate glass, an alumino-silicate glass, an alkali-free glass, a boro-silicate glass and the like. The glass may be regular a clear, colored or extra-clear (i.e. lower Fe content and higher transmittance) glass substrate. Further examples of glass substrates include clear, green, bronze, or blue-green glass substrates.

Examples of polymeric material sheets include poly(methyl meth)acrylate (PMMA), polycarbonates, polyethyleneterephthalate (PET), polyolefins, polyvinyl chloride (PVC), or mixtures thereof.

The patch is preferably a float glass patch having a thickness≤3 mm, preferably≤2.5 mm, more preferably≤1.8 mm. Thin patches are most preferred, that is, having a thickness≤1.2 mm, for their ease of fixing to the glazing pane.

Other examples include patches comprising reflective films suitable to reflect p-polarized light including films comprising at least one transparent liquid crystal layer; films comprising at least one cholesteric liquid crystal layers; films comprising a plurality of alternating polymeric interference layers, and the like.

For example, a reflective film comprising liquid crystal layers can be bonded to the surface of the patch as a functional foil, either to the first surface of the patch facing the internal surface of the glazing pane, or to the second surface of the patch facing the interior of the compartment.

The corresponding liquid crystal layers may be applied as a coating, for example, to carrier foils made of cellulose triacetate (TAC), polyethylene terephthalate (PET), polyethylene (PE), polyamide (PA) or other conventional polymeric materials. High precision coating processes for the manufacture of such functional liquid crystal films are available and known in the art and the functional films are commercially available.

Such layers, also called p-pol reflective films, are known. If other light/radiation is to be reflected, films may be chosen appropriately for s-polarized light or mixed polarized light.

Commercial examples of such reflective films include the Windshield Combiner Film available from 3M under the tradename 3M® WCF-PVB, or the reflective films available from Toray under the tradename PICASUS@VT, or the reflective films available from Fujifilm under the tradename Wavista®.

The reflective film may be applied to the patch using any known adhesion means, such optical clear resins and the like, to provide for a reflective patch.

Suitable optical clear resins have a refractive index about 1.4-1.6. Examples of optical clear resins include acrylic resin, methacrylate resin, urethane resin, silicone resin, polyester resin, epoxy resin and polysulfide resin.

Such optical clear resin is for example thermal cure type, high elongation silicone gel. The optical clear resin preferably cures at lower temperature than 70° C. during a period of 25 to 30 minutes to a soft, tacky gel. Optical clear resin may also be pressure sensitive adhesives, or any curable resin.

Application of such optical clear resins is well known in the art.

The transparency of the optical clear resin is >90%, preferably >95%, more preferably 99%. Thus, the glazing plane transmittance may be maintained, if so required.

The reflective patch is preferably applied to the surface side of the glazing pane facing towards the interior space.

The reflective patch may be fixed to the glazing pane during an autoclaving step. The autoclaving is a well know technique commonly used for automotive glazing. An interlayer (like PVB, EVA and others) can be used between the coated patch and the glazing pane. When the glazing pane is a laminated glazing pane, the coated patch can be attached at the same time as the lamination step, or may be positioned after said lamination step. This method is advantageous, for its ease of implementation in a single step. It also allows for fixing a reflective patch having the same curvature (if any) as the glazing pane.

The reflective patch may also be fixed to the glazing pane using the adhesion means above relying on optical clear resin. This method is advantageous for the ease of positioning of the patch on the glazing pane and may be effected after the glazing pane is assembled.

The thickness of the adhesion means may be different along the width of the surface of the reflective patch when the reflective patch surface is not parallel to the glazing pane surface to which it is adhered. Indeed, in some instances, the first surface of the patch facing the internal surface of the glazing pane, that is, the surface serving the adhesion to the glazing pane surface, will have a different (if any) curvature, than the glazing pane surface. The first surface of the reflective patch may be more or less curved than the glazing pane, such curvature of the reflective patch being irrespective of the potential curvature of the glazing pane.

The reflective patch may have a light transmittance≥60% or even ≥70%, when it requires application in a transparent zone of a glazing pane, which may be used as a vehicle windshield. However, the advantage of the present technical solution is that the reflective patch may have any light transmittance, from 0 to 92%, when the reflective patch is to be affixed on an obscurated zone of a glazing pane, said obscurated zone having a TL ≤30%.

In first instances, the at least one area provided with the reflective patch may have an initial light transmittance ≥60% (III. A, 2°), that is, the reflective patch may be affixed on a transparent area of the glazing pane, that is, an area of the glazing pane having a TL≥60%, preferably ≥70%, before the reflective patch may be affixed. This has the advantage that the display area may be in the sight line of the observer to whom the projected information is intended. The advantage is that the observer then sees the projected image in the overlapping area of the sight out of the glazing pane. In such first instances, the reflective patch may thus preferably have high transmittance in the visible spectral range and allow a color-neutral display, specifically if the reflective patch is positioned in the area if the glazing pane having a TL≥60%.

In the field of automotive and specifically windshields, norm ECE-R43 specifies the technical requirements that the central field of view of an automobile must have a high light transmission (typically greater than 70%). In such first instances, the reflective patch must thus satisfy the conditions of transparency according to norm ECE-R43.

In second instances, the at least one area provided with the reflective patch may have an initial light transmittance≤30% (III. A, 2°), that is, the reflective patch may be affixed on a non-transparent area of the glazing pane, that is, an area of the glazing pane having a TL≤30%, preferably≤15%, before the reflective patch may be affixed. In these instances, the advantage is that the projected image is out of sight of the viewing area of the observer. The quality and color of the reflective patch may then be adapted and require less technical and chemical constraints in terms of transparency and color neutrality. On the other hand, the reflective patch is thus also invisible or unnoticeable from the outside of the glazing pane. Further, reflectivity of an image from an area having a darker background is typically brighter. An additional advantage is that the reflective patch is protected against direct sun lights and that risks of damage or scratches is reduced since the obscurated area is generally on the glazing pane periphery and less reachable by driver or vehicle occupants.

Examples of opacifying means providing a glazing pane with a TL≤30% include a dark print, a dark insert, a dark patch, or combinations thereof.

Dark prints include enamels and paints, applied by screen printing or typical methods to deposit enamels and paints. Dark inserts include colored interlayers, inserted within the interlayer used to provide for a laminated glazing pane, or between the first surface of the reflective patch and the interior surface of the glazing pane, where it may serve as adhesion means such as during an autoclaving step. Dark patches may be incorporated within the reflective patch, that is, when the patch material (glass or polymer) is selected to have a TL≤30 %.

It may also be that the reflective patch overlaps both the areas of the glazing pane having a TL≥60% and having a TL≤30%, bridging an area of the glazing pane having two different light transmittance.

In both first and second instances, alone or combined, the present ramp profile has the advantage of smoothing the edge(s) of the perimeter of the reflective patch, such that the inner side of the glazing pane does not have an inaesthetic appearance of the reflective patch and such that dust does not remain stuck on the edge(s) of the reflective patch. Further, the reflective patch cannot easily be removed by mechanical (such as scratching) or cleaning actions.

The ramp profile is provided along a portion of at least one edge of the perimeter of the reflective patch. The ramp profile may be used to mask the thickness variation between the glazing pane and the reflective patch. In some embodiments, the ramp profile is provided over an upper portion of at least one edge of the perimeter of the reflective patch, or on a portion of an upper edge of the perimeter of the reflective patch.

The ramp profile may thus be used to guarantee a contact offset between a first area and a second area, specifically when there are different light transmittance between coated and uncoated areas.

Typically, the glazing pane may be inserted within a frame by a fastening means, such as a sealant, to attach the glazing pane to the interior space.

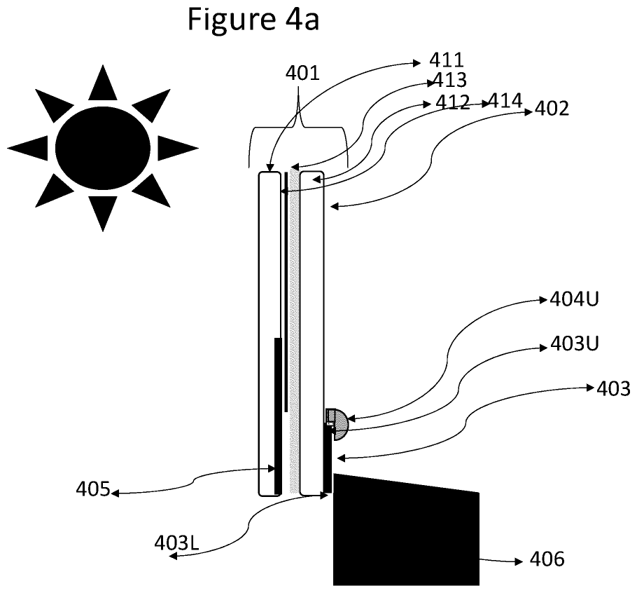

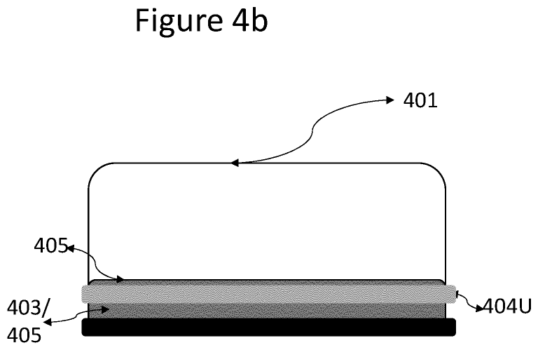

In some embodiments, at least a first portion of the perimeter will be apparent to the inside view, while a second portion may be hidden within the car body or side of the glazing pane within the fastening element (as illustrated by FIG. 4).

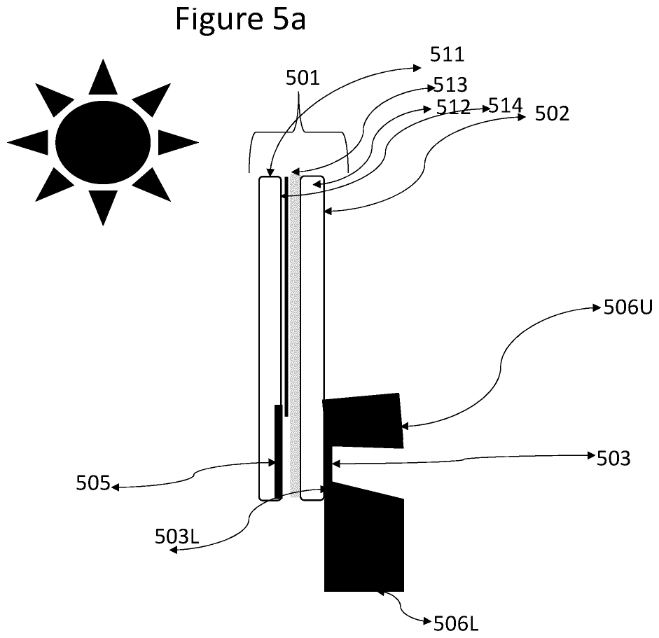

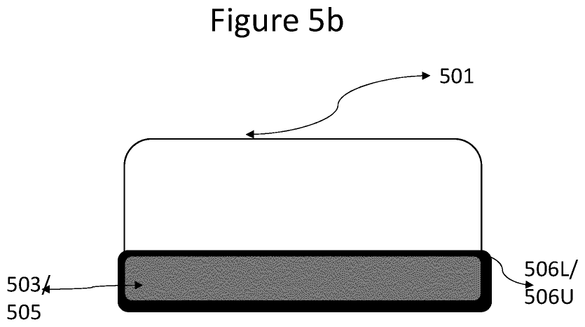

In other embodiments, the ramp profile can be part of the dashboard, said dashboard being designed such that it comprises an opening comprising the reflective patch affixed on the glazing pane, such that projection on a selected area of the windshield may occur. In such instances, no portion of the perimeter is effectively apparent to the inside view, as being hidden within the dashboard design covering around the perimeter (as illustrated by FIG. 5).

In some other embodiments, a ramp profile is provided along all the edge(s) of the perimeter of the reflective patch. The final aesthetics and positioning will determine the portion of the perimeter to be provided with the ramp profile.

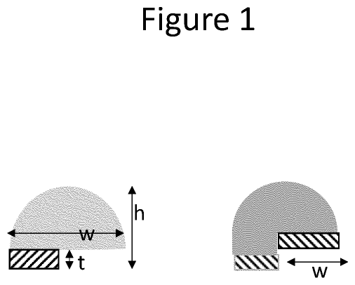

The ramp profile, as represented in FIG. 1, comprises at least a notch, with a thickness (t) corresponding to the thickness of the reflective patch.

The ramp profile may be designed according to the adhesion means thickness and the thickness of the reflective patch. As discussed above, the thickness of the adhesion means may be different along the width of the surface of the reflective patch when the reflective patch surface is not parallel to the glazing pane surface to which it is adhered. In those instances, the ramp profile will be designed such that its thickness entails the thickness of the adhesion means and the thickness of the reflective patch.

The ramp profile, as represented in FIG. 1, further comprises a width (w) and height (h) independently ranging from 0.4 to 30.0 mm, alternatively of from 1.0 to 20.0 mm.

In FIG. 1, the ramp profile is exemplified having a round (semi-circular) cross-section, but technically, any other cross-section may be presented, as best fits design and technical requirements. There are various options of protruding or smooth designs, provided the ramp profile serves the function of hiding a portion of at least one edge of the perimeter of the reflective patch.

This holds also true when the thickness of the adhesion means is different along the width of the surface of the reflective patch, provided the ramp profile serves the function of hiding a portion of at least one edge of the perimeter of the reflective patch.

The ramp profile may be made in polymer, preferably in thermoplastic polymer or thermoplastic elastomer, such as processed by extrusion or injection molding. Both methods allow for the production of continuous and uniform shapes fitting the required design. The ramp profile may be clear or transparent or colored, as typically acknowledged for these types of materials, and as most appropriate for the light transmittance of the background area on which it is fixed.

Examples of such materials include polyethylene terephthalate (PET), polyurethane resin, polyethylene, polypropylene, polystyrene, polyvinyl chloride (PVC), acrylonitrile butadiene-styrene (ABS), thermoplastic elastomers (TPEs), polyisobutylene, silicone, acrylic resin, cyano-acrylate, epoxy resin, polyamide, ethylene-vinyl acetate, polysulfide, butyl rubber, ethylene-propylene copolymer, styrene-butadiene rubber and mixtures or combinations thereof. These materials may be from biological origin (bio-based), recycled origin or chemical origin.

In some instances, the ramp profile may thus be an optical clear resin, specifically when the ramp profile is to be invisible to the occupant, or unnoticeable. This has the advantage of being less disturbing to the view and aesthetically pleasing on the surface of the glazing pane.

In other instances, when the ramp profile is an element of the dashboard, it may be of the same color and material of said dashboard, and thus be colored and non-transparent (such as typical AVO materials). This has the advantage that the element is structurally and aesthetically pleasing to the view as being an element of the interior design.

The ramp profile may be self-adhesive, or it may be affixed to the glazing pane via a separate adhesive, or via a primer. The adhesive may also be transparent, as will be required by the design.

Examples of adhesives include cyanoacrylate, epoxy resin, silicone adhesives, and mixtures or combinations thereof. These have the advantage of being transparent, temperature resistant, waterproof and having high strength.

The ramp profile may thus be opaque, colored or transparent, or translucent.

The present glazing pane may further comprise an IR reflective coating. In such instances, compatible with the present invention, the glazing pane is a laminated glazing pane comprising two glass sheets and at least one interlayer. The IR reflective coating may be present between the two glass sheets, either on the surface of at least one glass sheets, where it may be provided by chemical vapor deposition or physical vapor deposition on the glass sheet surface known as P2 or P3, or within the interlayer joining the two glass sheets, such as a PET-based solar control window film with infrared absorbing or reflecting ceramic coatings. Such IR reflective coatings are well known in the field to provide for sun control and/or heating functionality to the glazing pane.

In some instances, the IR reflective coating may be removed for use of IR-cameras or optical systems, such as LIDARS or else, distinct from the present HUD projector.

In order to avoid double images from said IR reflective coating, it may be useful to avoid overlap of the IR reflective coating with the reflective patch for the head up display.

Specifically, the glazing pane may be provided with an IR reflective coating in an area of the glazing pane having a TL>70%, and the reflective patch may be provided in an area of the glazing pane having a TL≤30%. In such way, the TTS (total transmission solar) may be optimized with values of less than 60%, alternatively less than 55%, while not compromising the functioning of the reflective patch for polarized light as discussed above. In such instances, the edge of the IR reflective coating may be hidden by the ramp profile, so as to avoid any visible change in aesthetics between the area provided with the IR reflective coating and the area free of said IR reflective coating (said coating may be decoated).

Laminated panes can be produced by methods known per se. Typically, the outer pane, the inner pane and the layers of the intermediate layer are stacked flat on top of each other. The surface of the outer pane facing the interlayer or the surface of the outer pane facing the interlayer may be entirely or partially provided with an IR reflective coating as discussed above. In some instances, the IR reflective coating is present within the interlayer. The reflective patch may be positioned and arranged on the surface of the inner pane opposite the interlayer, facing the interior of the vehicle (known as surface P4 in a laminated glazing).

The outer pane and the inner pane are laminated to one another via the interlayer, for example by autoclave processes, vacuum bag processes, vacuum ring processes, calendering processes, vacuum laminators or combinations thereof. The outer pane and inner pane are usually connected under the action of heat, vacuum and/or pressure.

The present glazing pane may be used as windshield, roof, cockpit, sidelight, backlight, among other vehicle applications, or curtain wall, window, door shop displays, fridge door, and the like for architectural applications.

Vehicles include land vehicle, sea vehicle, air vehicle or spacecraft.

The present invention also relates to a HUD system comprising the glazing pane described herein, and at least one projector emitting radiation, wherein the area of the inner pane provided with the reflective patch is a display area for an image projected by the at least one projector.

In such HUD system, the projector is oriented towards the HUD region, such that the projected image is reflected within the display area. The projector thus illuminates an area of the windshield where the radiation is reflected towards the viewer (driver), creating an image or a virtual image that the viewer sees behind the windshield as seen from inside (see-trough view). The area of the windshield that can be irradiated by the projector may be referred to as the HUD area.

Such projectors are typically known in the art and will not be described herein.

Typically, current HUD projectors operate predominantly with s-polarized radiation and illuminate the windshield at an angle of incidence of approximately 65°. The problem arises that the projector image is reflected on both external surfaces of the windshield (known as the air/glass interfaces of P1 and P4). As a result, in addition to the desired main image, a slightly offset secondary image also appears, the so-called ghost image (“ghost”). Different means may be used to alleviate this issue, such as wedge interlayers. Another means to alleviate this issue is to reduce the transmitted radiation towards the external glass sheets, by having an HUD area having a TL<30%.

In the scope of the present invention, the radiation beam from the projector may be 20 to 100% p-polarized light. The image formed by the projected beam of the HUD projector may thus be comprised of mixed light polarization wherein the percentage of p-polarized light is at least 20%, preferably at least 50%, more preferably at least 75%, even more preferably at least 90%, most preferably 100%.

As a result, the radiation provided by the projector can be advantageously reflected by the reflective patch, specifically when the TL of the HUD area is ≥70%. There is less criticality in the proportion of non p-polarized light when the HUD area is in area of the glazing pane having a TL<30%, since the projected image will not be transmitted or reflected through the external air-glass surface. One additional advantage of working with a p-polarized beam is the compatibility of the image or virtual image with polarized sunglasses.

The radiation from the projector strikes the display area provided with the reflective patch, at an angle of incidence of 50 to 75° incident angle.

The present invention last relates to the use of a ramp profile to secure fastening of at least a portion of the perimeter of a reflective patch affixed on the inner surface of a glazing pane separating an interior space from an exterior environment, said glazing pane having one inner surface facing the interior space and one outer surface facing the exterior environment, and said ramp profile being positioned along at least a portion of the reflective patch perimeter.

The present invention is illustrated by the below embodiments, compatible with one another.

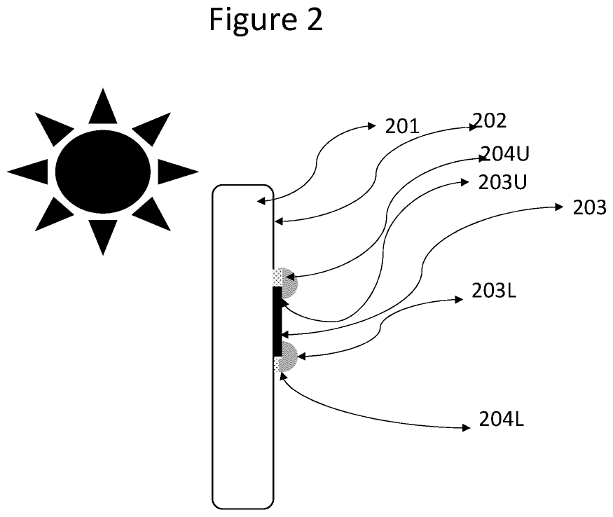

FIG. 2 shows a cross section (lateral view) of a glazing pane (201), comprising an inner surface (202) and a reflective patch (203), having 4 edges affixed on said inner surface. The reflective patch perimeter has 4 edges: the lower edge (203L), an upper edge (203U); and a right edge and a left edge (not shown). The area of the glazing pane (201) provided with the reflective patch (203) in FIG. 2 has a TL≥70%. A ramp profile (204L) is affixed on the lower edge (203L) and a ramp profile (204U) is affixed on the upper edge (203U). A ramp profile may also be present on each of the right and left edges (not shown).

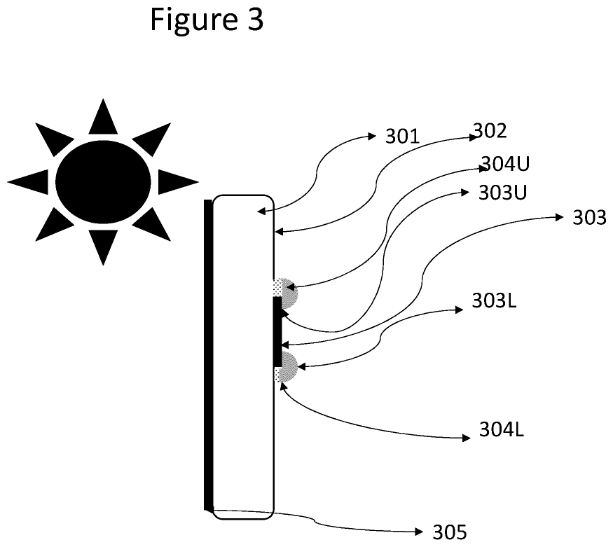

FIG. 3 shows a cross section (lateral view) of a glazing pane (301) similar to FIG. 2, comprising an inner surface (302) and a reflective patch (303), wherein a delimited zone of an obscurated area of the glazing pane (301), said obscurated area having a TL≤30%, is provided with said reflective patch (303). Said area is provided with an obscuration means (305) such as discussed above, for example enamel or paint. The said area may be the blackband area or any obscurated area of the glazing pane. A ramp profile (304L) is affixed on the lower edge (303L) and a ramp profile (304U) is affixed on the upper edge (303U). A ramp profile may also be present on each of the right and left edges (not shown).

FIG. 4 shows a cross section (lateral view) of a glazing pane (401), which is a laminated glazing pane, composed of two glass sheets (411 and 412) and one interlayer (413), having an inner surface (402)—contact between the elements is implied although not drawn for the sake of clarity. Again, a delimited zone of an obscurated area of the glazing pane (401), said obscurated area having a TL≤30%, is provided with the reflective patch (403). Said area is provided with an obscuration means (405) such as discussed above, for example enamel or paint or dark interlayer, here in position 2 of the laminated glazing pane. The reflective patch perimeter has 4 edges: the lower edge (403L), an upper edge (403U); and a right edge and a left edge (not shown). A ramp profile (404U) is affixed on the upper edge (403U), while the car body (405) is hiding and covering the lower edge (403L). A ramp profile may be provided on each of the sections of right and left edges not hidden in the car body (not shown). In this particular case, an IR reflective coating (414) may be provided within the interlayer (413) of deposited on either one of the surfaces of the sheets (411) and (412) facing the interlayer. It may also be appropriate, such as illustrated, that the IR reflective coating (414) does not overlap with the reflective patch (403), and that the bottom edge of the IR reflective coating (414) is hidden by the ramp profile.

FIG. 4b shows a front projection of the glazing pane with the reflective patch (403), in the line of view of the obscuration band (405), as seen from the perspective of the occupant (see-through perspective). The reflective patch is affixed and positioned on the glazing pane (501), such that projection and reflection may occur on the obscuration band region of the windshield. The bottom portion of the perimeter of the reflective patch is hidden by the car body (405) while a ramp profile of thermoplastic material is provided on the upper edge, being transparent to the view, such that only the appearance of the obscuration band is noticed by the occupant (404U preferably being transparent).

FIG. 5a shows a cross section (lateral view) of a glazing pane (501), which is a laminated glazing pane, composed of two glass sheets (511 and 512) and one interlayer (513), having an inner surface (502)—contact between the elements is implied although not drawn for the sake of clarity. Again, a delimited zone of an obscurated area of the glazing pane (501), said obscurated area having a TL≤30%, is provided with the reflective patch (503). Said area is provided with an obscuration means (505) such as discussed above, for example enamel or paint or dark interlayer, here in position 2 of the laminated glazing pane. The material of the reflective patch may also be dark and/or colored, having a TL≤30%. The reflective patch perimeter has 4 edges: the lower edge (503L), an upper edge (503U); and a right edge and a left edge (not shown). A ramp profile (506U and 506L) is affixed along all the edges of the reflective patch perimeter, in the form of a part of the dashboard. An IR reflective coating (514) may be provided within the interlayer (513) of deposited on either one of the surfaces of the sheets (511) and (512) facing the interlayer. It may also be appropriate, such as illustrated, that the IR reflective coating (514) does not overlap with the reflective patch (503), and that the bottom edge of the IR reflective coating (514) is hidden by the ramp profile designed in the dashboard structure.

FIG. 5b shows a front projection of the glazing pane with the dashboard being designed such that it comprises an opening comprising the reflective patch (503), in the line of view of the obscuration band (505), as seen from the perspective of the occupant (see-through perspective). The reflective patch is affixed and positioned on the glazing pane (501), such that projection and reflection may occur on the obscuration band region of the windshield. The entire portion of the perimeter of the reflective patch is effectively hidden to the inside view, as being hidden within the dashboard design covering around the perimeter.

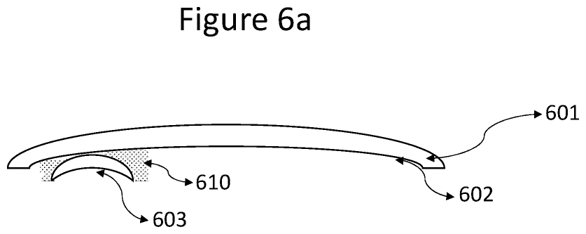

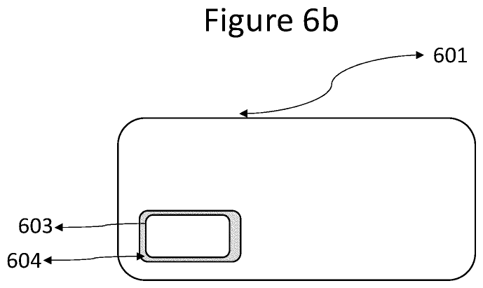

FIG. 6a shows a cross section (top view) of a glazing pane (601), comprising an inner surface (602) and a reflective patch (603) having a perimeter (not shown). The reflective patch (603) is adhered to the inner surface (602) by an adhesion means (610) having a different thickness along the width of the reflective patch (603). The ramp profile is not designed on FIG. 6a, although it is present on FIG. 6b.

FIG. 6b shows a front projection of the glazing pane (601) comprising the reflective patch (603) adhered to the inner surface by an adhesion means (610) not shown. The ramp profile (604) is provided along the perimeter of the reflective patch (603). The reflective patch of FIG. 6 may be affixed to any area of the glazing pane, irrespective of the light transmittance of said area, such as discussed in other embodiments of the present invention.

1. A glazing pane separating an interior space from an exterior environment, having one inner surface facing the interior space and one outer surface facing the exterior environment, wherein the inner surface is provided in an area with a reflective patch having a perimeter, wherein the reflective patch has a ramp profile along at least a portion of its perimeter.

2. The glazing pane according to claim 1, wherein the reflective patch is a coated patch with a reflective coating suitable to reflect p-polarized light or wherein the reflective patch comprises a reflective film suitable to reflect p-polarized light selected from films comprising a transparent liquid crystal layer; films comprising a cholesteric liquid crystal layers; and films comprising a plurality of alternating polymeric interference layers.

3. The glazing pane according to claim 1, wherein the ramp profile is selected from a material from the group consisting of polyethylene terephthalate (PET), polyurethane resin, polyethylene, polypropylene, polystyrene, polyvinyl chloride (PVC), acrylonitrile butadiene-styrene (ABS), thermoplastic elastomers (TPEs), polyisobutylene, silicone, acrylic resin, cyano-acrylate, epoxy resin, polyamide, ethylene-vinyl acetate, polysulfide, butyl rubber, ethylene-propylene copolymer, styrene-butadiene rubber and mixtures or combinations thereof.

4. The glazing pane according to claim 1, wherein the glazing pane is selected from single sheet of glass or polymer, or may be a laminated pane of glass and/or polymeric material.

5. The glazing pane according to claim 4, wherein the glazing pane is a laminated glazing pane comprising at least two glass sheets and at least one interlayer.

6. The glazing pane according claim 1 further comprising an IR reflective coating.

7. The glazing pane according to claim 1, wherein the area provided with the reflective patch has a light transmittance≥60% (Ill. A, 2°).

8. The glazing pane according to claim 1, wherein the area provided with the reflective patch has a light transmittance≤30% (Ill. A, 2°).

9. The glazing pane according to claim 8, wherein the area having a TL≤30% is provided with an opacifying means, including a dark print, a dark insert, a dark patch, or combinations thereof.

10. A HUD system comprising the glazing pane of claim 1, and a projector emitting radiation, wherein the area of the glazing pane provided with the reflective patch is a display area for an image projected by the projector.

11. The HUD system of claim 10, wherein the radiation emitted from the projector is 50 to 100% p-polarized light.

12. The HUD system of claim 10, wherein the radiation emitted from the projector strikes the display area provided with the reflective patch, at an angle of incidence of 40° to 75°.

13. A method of securing fastening of a portion of the perimeter of a reflective patch affixed on the inner surface of the glazing pane separating an interior space from an exterior environment according to claim 1, wherein said glazing pane has one inner surface facing the interior space and one outer surface facing the exterior environment, and said ramp profile is positioned along at least a portion of the reflective patch perimeter, the method comprising using the ramp profile to secure fastening of the portion of the perimeter of the reflective patch.
